(19) United States
(12) Patent Application Publication
(10) Pub. No.: US 2012/0215664 A1
(43) Pub. Date: Aug. 23, 2012

(54) EPURCHASE MODEL

(75) Inventors: Vipul C. Dalal, Sunnyvale, CA (US); Jing Chen, Milpitas, CA (US); Venkat Sundaranatha, San Jose, CA (US); James Ladd, San Jose, CA (US); Jay Katukuri, Santa Clara, CA (US); Ashok Ullal Mallya, San Jose, CA (US); Ayon Sinha, Sunnyvale, CA (US)

(73) Assignee: eBay Inc., San Jose, CA (US)

(21) Appl. No.: 13/030,026

(22) Filed: Feb. 17, 2011

(51) Int. Cl. G06F 15/18; G06Q 30/00

(52) U.S. Cl. 705/27.1; 706/12

(57) ABSTRACT

In various example embodiments, a system and associated method to enhance a user experience in an online environment is provided. In one embodiment, the method includes receiving a request over a network from a user where the request includes keywords to be used in a search for one or more items; the results from the search being displayed in a webpage. A determination is made whether to track metrics related to user activities associated with the results from the search. Based on a determination that the user activities are to be tracked, determining factors based on the tracked metrics related to the user activities, calculating a predictive model using one or more processors based on the determined factors, and displaying an enhanced webpage where components in the enhanced webpage are based on the predictive model.

### TECHNICAL FIELD

The present application relates generally to the field of computer technology and, in a specific example embodiment, to a system and method to learn and deploy an optimal or enhanced user experience in an online marketplace system.

### BACKGROUND

Conventional online purchasing websites and systems, such as Amazon.com, may use a buyer's previously purchased product, product category, or product genre to suggest new products in a same or similar category or genre for the user. However, these online purchasing websites are typically one-dimensional; that is, a one-dimensional input (e.g., a given product category or genre) leads to a one-dimensional output (e.g., new products in a same or similar category or genre). These conventional systems do not utilize multi-dimensional context analysis to provide a multi-dimensional output based on, or customized from, a collection of activities from a community of users gathered over time.

### BRIEF DESCRIPTION OF DRAWINGS

In the following detailed description of example embodiments of the inventive subject matter, reference is made to the accompanying drawings which form a part hereof, and which is shown by way of illustration only, specific embodiments in which the inventive subject matter may be practiced. It is to be understood that other embodiments may be utilized and structural changes may be made without departing from the scope of the present invention.

FIG. 1 is a block diagram illustrating an example embodiment of a high-level client-server-based network architecture diagram depicting a system used to process end-user queries;

FIG. 2 is a block diagram illustrating an example embodiment of various modules of the network architecture of FIG. 1;

FIG. 3 is a block diagram of an example embodiment of an architecture to implement an e-purchase model into the network architecture of FIG. 1;

FIG. 4A is a block diagram of a user community benefiting from the e-purchase model implemented in the network architecture of FIG. 1;

FIG. 4B is a block diagram of a specific example embodiment of the block diagram of FIG. 4A;

FIG. 5 is a block diagram of multiple input dimensions and multiple output dimensions of a specific example embodiment;

FIG. 6A is a graphical representation of impressions based on keyword inputs from a user;

FIG. 6B is a representation of a portion of a web browser that can affect calculation of impressions of FIG. 4A;

FIG. 6C is a representation of a portion of a web browser that can affect calculation of impressions of FIG. 4A;

FIG. 7 is a diagram of a hierarchy of user events that are used in a specific example embodiment of the e-purchase model;

FIG. 8 is a flowchart of user events that are used in a specific example embodiment of the e-purchase model; and

FIG. 9 is a simplified block diagram of a machine in an example form of a computing system within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody the inventive subject matter presented herein. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on end-user queries in an electronic retail or marketplace environment, the embodiments are given merely for clarity in disclosure. Thus, any type of electronic commerce or electronic business system and method, including various system architectures and publication systems, may employ various embodiments of the end-user search and predictive modeling system and method described herein and are considered as being within a scope of the present invention.

In general terms, various embodiments of the inventive subject matter described herein serve to develop a model to predict purchases in a marketplace using various activities of an end-user acting as a buyer. The end-user activities can include searches based on particular key words, viewing items resulting from the search, items being added to a watch list of the end-user, and numerous other variables discussed in more detail, below. The predictive model results in a number of advantageous benefits to the marketplace community by being designed to learn and deploy an optimal or enhanced user-experience in an online marketplace system.

For example, the models described herein can provide early insight into performance of new features being launched on site. Normally, when a user purchases items from a given online marketplace, a variety of activity goes into a purchase decision. For example, the user will enter keywords to search for a given item, evaluate prices and features of various items returned in a search results page, view one or more of the items in the results page, view shipping prices, and so on. There are a number of factors that go into the buying decisions of the user. For an online auction, the number of factors is even greater. For example, an auction listing typically takes at least seven days to close. During that time, the user may perform all of the above activities listed with reference to the online purchase. However, during an auction the user may re-visit the site several times, add an item to the user's watch-item page, and search multiple times for similar items before the user even places an initial bid on the item. Therefore, it can take several weeks to glean through all the generated data produced by thousands or even millions of people viewing and bidding on a given item. Thus, the results of bid decisions based on any changes to the auction site, such as, for example, listing the item with a single picture versus showing the item with numerous, albeit perhaps smaller pictures can only be evaluated long after the item is sold. Although such data may be applicable to future auctions of similar items, the feedback loop is far too long to be applied successfully. Thus, the example predictive model presented herein has several advantages such as, for example, an early insight into the performance of new features being launched on a site.

Additionally, since more data are generated in an auction versus a conventional purchase, the auction can provide a larger signal (e.g., more data and consequently more variables to be plugged into the predictive model) than on a conventional purchase. The larger signal comes about as a result of a user performing more activities during an auction than during a conventional purchase. Thus, examples of user activities may include (1) watching an item; (2) repeat visits of a watched item; (3) number of bids on an item; (4) visiting a feedback page of a seller of the item; (5) the amount of time the user has a window open of the item; 6) using a “Buy It Now” feature of an item listing (versus bidding on the item); and many other activities that can contribute to variables of the predictive models. Thus, various aspects on the inventive subject matter discussed herein allow granular and timely insights vis-a-vis purchases for buyer experience. For example, based on the models discussed, an optimal or enhanced user experience in an online marketplace system can be realized by, for example: (1) getting timely insights into various treatments running on the online marketplace system; and (2) getting granular insights at category levels for different treatments for items available for bid or purchase on the online marketplace system.

In general, various embodiments use context input, including user and query information and user activity feedback to automatically generate and display the most relevant or most likely user-favored next page for that context using the predictive model. User information can include explicitly or implicitly obtained demographic information, explicitly or implicitly obtained user profile information, user transaction history, user activity history, or any other information explicitly or implicitly obtained that may indicate user preferences. Additionally, a perturbation engine can be used to include, for some users, a slightly sub-optimal selection of page type, widget set, or configuration to cause the system to re-affirm the optimal selections and to introduce new selections that may have otherwise not been considered or selected. The perturbation engine enables a particular user or set of users to be exposed to a selection of page type, widget set, or configuration to which the user may not have otherwise been exposed. In some cases, a particular user or set of users can be exposed to a sub-optimal or under-performing selection of page type, widget set, or configuration.

In an example embodiment, a method (and related non-transitory machine-readable storage medium, e.g., a DVD or CD-ROM, for storing the method) of enhancing a user experience in an online environment includes receiving a request over a network from a user where the request includes keywords to be used in a search for one or more items; the results from the search being displayed in a webpage. A determination is made whether to track metrics related to user activities associated with the results from the search. Based on a determination that the user activities are to be tracked, determining factors based on the tracked metrics related to the user activities, calculating a predictive model using one or more processors based on the determined factors, and displaying an enhanced webpage where components in the enhanced webpage are based on the predictive model.

In an example embodiment, a system to enhance a user experience in an online environment includes a parallel processing engine to determine whether to track metrics related to user activities associated with results from a search based on keywords submitted by the user. The parallel processing engine also calculates a predictive model based on a set of determined factors based on the tracked user activities. A user experience optimizer compiles information received from the parallel processing engine to prepare a webpage based upon the information received from the parallel processing engine. A sojourner engine tracks metrics related to user activities associated with results from the search, and a singularity engine removes outliers from the tracked metrics received from the sojourner engine. The results from the tracked metrics with the removed outliers are to be used as an input to the parallel processing engine. Each of these example embodiments, and others, is discussed in detail, below.

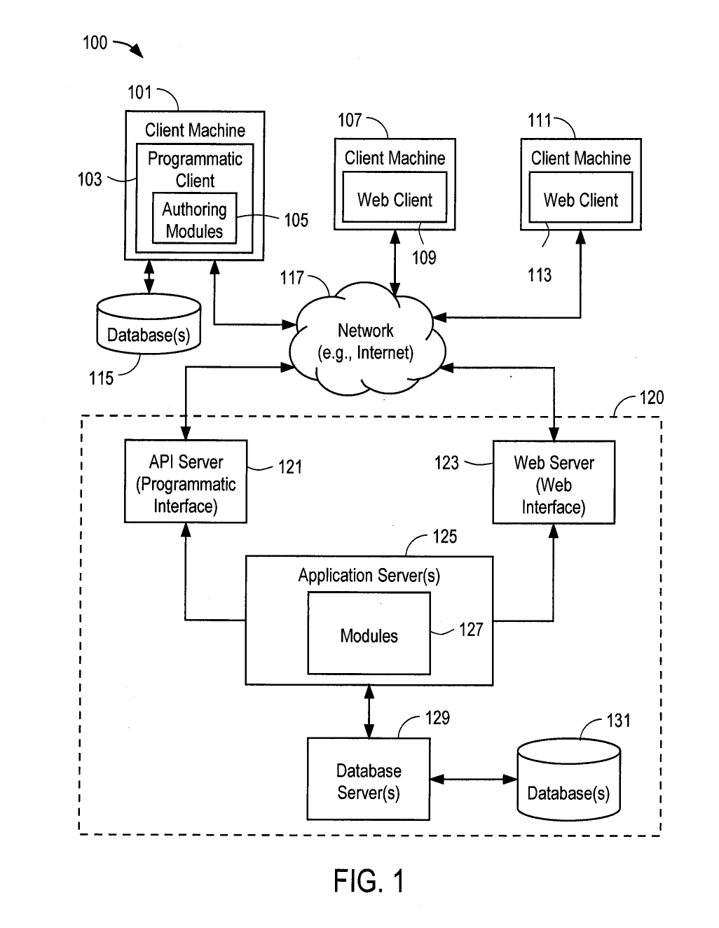

With reference to FIG. 1, a high-level network diagram of an embodiment of an example system 100 with a client-server architecture includes a first client machine 101, a second client machine 107, a third client machine 111, a network 117 (e.g., the Internet), and an information storage and retrieval platform 120. In this embodiment, the information storage and retrieval platform 120 constitutes a commerce platform or commerce server and provides server-side functionality, via the network 117, to the first 101, second 107, and third 111 client machines. A programmatic client 103 in the form of authoring modules 105 executes on the first client machine 101. A first web client 109 (e.g., a browser, such as the Internet Explorer browser developed by Microsoft Corporation of Redmond, Wash.) executes on the second client machine 107. A second web client 113 executes on the third client machine 111. Additionally, the first client machine 101 is coupled to one or more databases 115.

Turning to the information storage and retrieval platform 120, an application program interface (API) server 121 and a web server 123 are coupled to, and provide programmatic and web interfaces respectively to, one or more application servers 125. The application servers 125 host one or more modules 127 (e.g., modules, applications, engines, etc.). The application servers 125 are, in turn, coupled to one or more database servers 129 facilitating access to one or more information storage databases 131. The one or more modules 127 provide a number of information storage and retrieval functions and services to users accessing the information storage and retrieval platform 120. The one or more modules 127 are discussed in more detail, below.

While the example system 100 of FIG. 1 employs a client-server architecture, a skilled artisan will recognize that the present disclosure is not limited to such an architecture. The example system 100 could equally well find application in, for example, a distributed, or peer-to-peer, architecture system. The one or more modules 127 and the authoring modules 105 may also be implemented as standalone software programs, which do not necessarily have networking capabilities.

The first 109 and second 113 web clients access the one or more modules 127 via the web interface supported by the web server 123. Similarly, the programmatic client 103 accesses the various services and functions provided by the one or more modules 127 via the programmatic interface provided by the API server 121. The programmatic client 103 is, for example, a seller application (e.g., the “Turbo Lister 2” application developed by eBay® Inc., of San Jose, Calif.) enabling sellers to author and manage data items or listings on the information storage and retrieval platform 120 in an off-line manner. Further, batch-mode communications can be performed between the programmatic client 103 and the information storage and retrieval platform 120. In addition, the programmatic client 103 can include, as previously indicated, the authoring modules 105 used to author, generate, analyze, and publish domain rules and aspect rules. The domain and aspect rules are used in the information storage and retrieval platform 120 to structure the data items and transform queries. Such domain and aspect rules are known independently in the art.

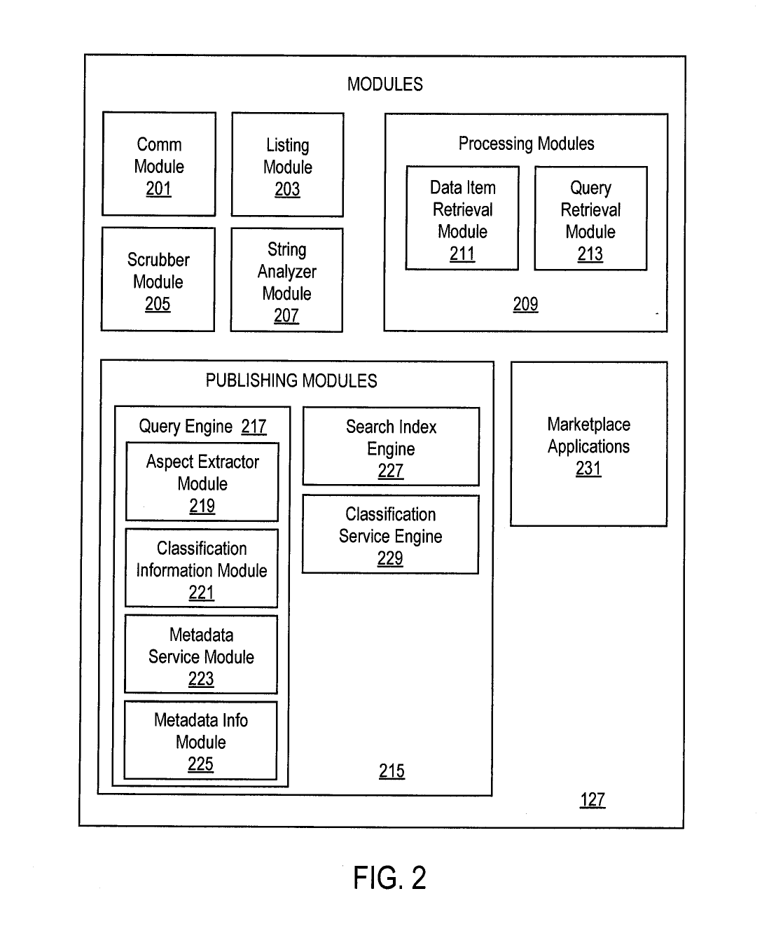

Referring now to FIG. 2, an example block diagram of the one or more modules 127 of FIG. 1 is shown to include a communication module 201, a listing module 203, a scrubber module 205, a string analyzer module 207, a plurality of processing modules 209, and publishing modules 215. The one or modules 127 further includes a marketplace applications block 231.

The communication module 201 receives a query from one or more of the client machines 101, 107, 111 (see FIG. 1). The query includes one or more constraints (e.g., keywords, categories, or information specific to a type of data item). The communication module 201 interacts with a query engine 217 and a search index engine 227, both located in the publishing modules 215, to process the query. In conjunction with the query engine 217 and the search index engine 227, the communication module 201 attempts to extract aspect-value pairs (e.g., brand=“Donna Karan” or “DKNY”) based on the query. Details of the aspect-value pairs are described in more detail, below.

The publishing modules 215 publish new or existing rules, as discussed above with reference to FIG. 1, to the information storage and retrieval platform 120, thereby enabling the rules to be operative (e.g., applying the rules to data items and queries). In a specific example embodiment, the information storage and retrieval platform 120 of FIG. 1 may be embodied as a network-based marketplace that supports transactions of data items or listings (e.g., goods or services) between sellers and buyers. One such marketplace is eBay, The World's Online Marketplace®, developed by eBay Inc., of San Jose, Calif. In this embodiment, the information storage and retrieval platform 120 receives information from sellers describing the data items. The data items are subsequently retrieved by potential buyers or bidders. The one or more modules 127 include the marketplace applications block 231 to provide a number of marketplace functions and services to end-users accessing the information storage and retrieval platform 120.

The publishing modules 215 further include a classification service engine 229. The classification service engine 229 applies domain rules to identify one or more domain-value pairs (e.g., product type=women's blouses) associated with the data item. The classification service engine 229 further applies the aspect rules to identify aspect-value pairs associated with the data item. The classification service engine 229 applies the domain and aspect rules to data items or listings as they are added to the information storage and retrieval platform 120 or responsive to the publication of new rules (e.g., domain rules or aspect rules). The scrubber module 205 utilizes services of the classification service engine 229 to structure the item information in the data item (e.g., the classification service engine 229 applies domain and aspect rules). The classification service engine 229 then pushes or publishes item search information over a bus (not shown but implicitly understood by a skilled artisan) in real time to the search index engine 227.

The search index engine 227 includes search indexes and data item search information (e.g., including data items and associated domain-value pairs and aspect-value pairs). The search index engine 227 receives the query from the communication module 201 and utilizes the search indexes to identify data items based on the query. The search index engine 227 communicates the found data items to the communication module 201.

A query retrieval module 213, within the plurality of processing modules 209, receives information from one or more of the client machines 101, 107, 111 and stores the information as a data item in the one or more information storage databases 131 (see FIG. 1). For example, an end-user, acting as a seller and operating on one of the client machines, enters descriptive information for the data item to be offered for sale or auction through the information storage and retrieval platform 120.

The plurality of processing modules 209 receives classification information and metadata information associated with the data item. The information is published to, for example, a local backend server (not shown) hosting the query engine 217, the search index engine 227, and the classification service engine 229.

The plurality of processing modules 209 further includes a data item retrieval module 211 to receive requests for data items from a client machine. For example, responsive to receiving a request, the data item retrieval module 211 reads data items from the data item information stored on the one or more information storage databases 131 (FIG. 1) and stores the data items as sample information in the one or more databases 115 for access by the client machine. Responsive to receiving the request, the query retrieval module 213 reads queries from the sample information and communicates the queries to the client machine.

The string analyzer module 207 receives requests from the first client machine 101 to identify candidate values to associate with an aspect. The request may include the aspect and one or more values that have been associated with the aspect. The string analyzer module 207 utilizes the aspect (e.g., “color”) to identify strings of text in a database that includes the aspect. The string analyzer module 207 relies on various services provided in the information storage and retrieval platform 120 to identify and process the strings of text. For example, the string analyzer module 207 utilizes services that expand the aspect to a derivative form of the aspect including a singular form (e.g., “color”), a plural form (e.g., “colors”), a synonymous form, an alternate word form (e.g., “chroma,” “coloring,” or “tint”), a commonly misspelled form (e.g., “collor”), or an acronym form.

A database (not shown specifically) used by the string analyzer module 207 includes queries or data items that have been entered by a user (e.g., buyer or seller, respectively although a seller may wish to enter queries as well) to the information storage and retrieval platform 120. The database can also store or reference dictionaries, thesauruses, or other reference sources. The string analyzer module 207 analyzes the strings of text to identify candidate values to associate with the aspect. More examples of query strings and searching techniques are given, below.

The query engine 217 includes an aspect extractor module 219, a classification information module 221, a metadata service module 223, and a metadata information module 225. The aspect extractor module 219 receives a query from the communication module 201 and applies aspect rules to extract aspect-value pairs from the query. Further, the aspect extractor module 219 communicates the query received from the communication module 201 to the plurality of processing modules 209 that stores the query as sample query information.

The classification information module 221 includes phrases from a plurality of past searches to reference against the query. For example, synonyms or related information for a query can be stored in the classification information module 221 to aid a user in locating an item or a particular set of items.

The metadata service module 223 communicates descriptive metadata information to the communication module 201 based on a query received from the communication module 201. The metadata information is retrieved from the metadata information module 225 and includes metadata that the communication module 201 uses to format and generate a user interface to provide additional information to the user based on the original user-generated query.

Once aspect-value pairs, classification information, and other relevant information is retrieved through, for example, either the data item retrieval module 211 or the query retrieval module 213, the listing module 203 provides additional assistance to a user listing the data item. The additional assistance can be, for example, one or more interfaces for the user to upload photographs, textual descriptions, and bidding information.

Although the one or more modules 127 have been defined in terms of a variety of individual modules and engines, a skilled artisan will recognize that many of the items can be combined or organized in other ways. The description given herein simply provides an example embodiment to aid the reader in an understanding of the systems and methods used herein.

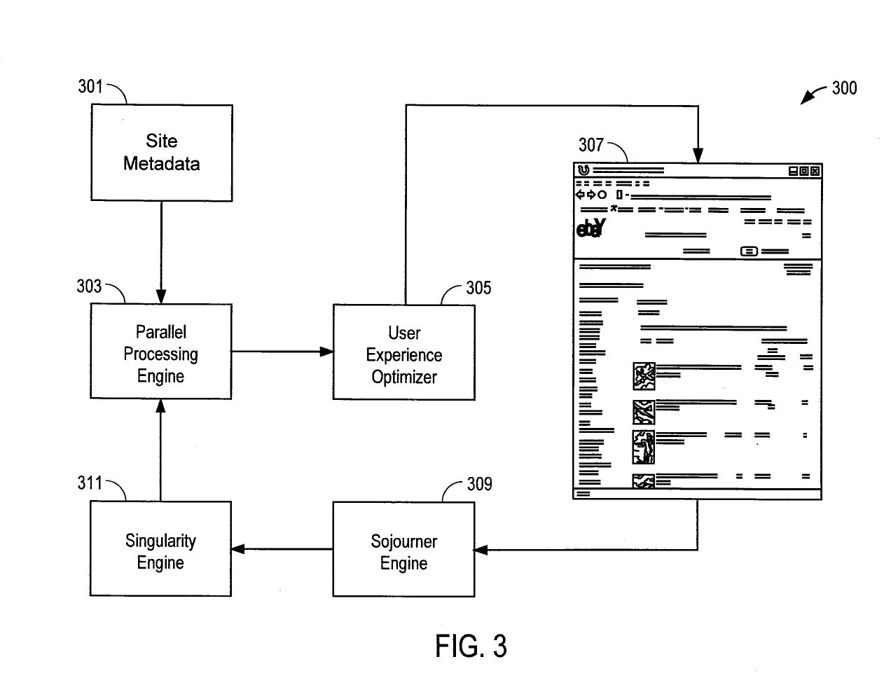

With reference now to FIG. 3, a simplified view of a block diagram 300 is shown of an example embodiment of an architecture to implement an e-purchase or predictive model into the network architecture of FIG. 1. The block diagram 300 is shown to include site metadata 301, a parallel processing engine 303, and a user experience optimizer 305. Overall, monitoring user activity in an online marketplace provides feedback or metrics that can be used to improve the site and, consequently, the user's level of a useful or pleasurable experience with the marketplace. For example, after a keyword search, one or more items resulting from the search are displayed in a webpage 307 on a browser of the user's computer, smart phone, or other electronic device. Depending on how the items are displayed (e.g., a list view or a gallery view) can affect the user's experience with the marketplace. Additionally, once the user selects a particular item, a subsequent webpage can also affect the user's experience. The number of photographs of an item, the size of the photographs, the amount of information about the item, feedback about the seller, and a multitude of additional information can all add or detract from the user's experience. Data are collected from activities of the user in a sojourner engine 309 and, after, for example, some initial filtering in the sojourner engine 309, much or all of the data are fed into a singularity engine 311 to remove outlier data. Each of these various engines is discussed in more detail, below. Further, in a specific example embodiment, a skilled artisan will recognize that each of the engines may be constructed from hardware (e.g., including one or more processors) combined with appropriate software or firmware to render the hardware into a specialized machine.

Overall, the block diagram 300 provides feedback information to apply towards gathering metrics about a particular cite by, for example, (1) getting timely insights into various treatments running on the site; (2) getting granular insights at a category level for different treatments; and (3) using the feedback and metrics to make future decisions on an optimal experience for the user by employing the predictive model. Once a user places a query, the keyword or keywords from the query are matched against information stored in the site metadata 301.

The site metadata 301 can include a repository of stored information relating to items contained on the site including, for example, classification information and metadata information associated with the data item. As noted above with reference to FIG. 2, the site metadata 301 may be contained or stored within the classification information module 221, the metadata service module 223, or the metadata information module 225. Once a query is received from an end-user, the query engine (e.g., the query engine 217 of FIG. 2) checks for matching data within the site metadata 301.

The parallel processing engine 303 makes a determination whether to start tracking metrics for the query to feed into the predictive model. Additionally, based on additional information received from the sojourner engine 309 and the singularity engine 311, discussed below, the parallel processing engine 303 performs calculations on the predictive model, also discussed below. Results from the calculations are fed forward into the user experience optimizer 305. In a specific example embodiment, the parallel processing engine can include an open source parallel processing environment. One such open source parallel processing environment is a distributed file system of Apache Hadoop. Hadoop is licensed by The Apache Software Foundation, a Corporation of the State of Delaware, USA. Hadoop runs on machine hardware in the form of massively parallel processors.

In an embodiment, the parallel processing engine 303 makes a determination of when to begin recording a user session, as noted briefly, above. The user session can be considered as comprising one or more finding attempts. One intention of a finding attempt is to capture a user's search for a given item; that is, the intent of the user's search. Finding attempts can be defined based on a series of breaking events that aim to ascertain the user intent. For example, a finding attempt begins when a user enters a search on the site or browses into a category hierarchy. In a specific example embodiment, a finding attempt ends when one of the following example breaking events occurs: a timeout after a period of user inactivity (e.g., after 30 minutes); a breaking page is entered by the user (e.g., the user goes to “My eBay” or some other page unrelated to the current search query); or the user enters a new search query that does not contain the initial search keywords (e.g., “Wii” to “Wii Games” or “Wii” to “new Wii” are both considered as non-breaking events; however, “Wii” to “Red Dress” is considered a breaking event). Additionally, further queries are not considered to be a breaking event as long as at least a portion of the initial keyword is present (e.g., “Wii” to “Wii Games” to “Wii Mario Games” is considered as a series of non-breaking events). Further, a user-entered category constraint on a different level in the same category as the currently selected category is considered a non-breaking event. For example, a user constrains on a level 1 category of “Collectibles,” then to a level 2 category of “Militaria.” This would not constitute a breaking event since “Militaria” is a child of “Collectibles,” therefore, the parallel processing engine 303 considers this as the same intent of the user. However, if a user constrained on the level 1 category of “Collectibles” and then constrained on a level 1 category of “Clothing, Shoes, and Accessories (CSA),” this would be considered as a breaking event since the user's intent is changing as evidenced by the selection of a new level 1 category. A user can also constrain on multiple children of a given parent node, in turn, while browsing without being considered as a breaking event. For example, going from the level 1 category of “CSA” to a level 2 category of “Mens' Clothing” back to “CSA” and then to “Womens' Clothing” are, all considered the same intent and therefore are not counted as breaking events. Rules regarding breaking and non-breaking events may be stored in the parallel processing engine 303 to assist in a determination of when to track activities of a user or when new activities should be tracked.

Once the parallel processing engine 303 makes a determination of either a user session occurring, or the continuation of a prior session continuing, both based, for example, upon the determination of the user's intent as defined, above, the information, along with any other calculated predictive model information, defined below, are fed into the user experience optimizer 305. The user experience optimizer 305 compiles the received information and prepares a particular version of the webpage 307 based upon the input received from the parallel processing engine 303. However, if a particular version of the webpage 307 is updated too frequently by the user experience optimizer 305, then the constant change can lead to a bad user experience. Therefore, a consideration may be given to frequency of updates (e.g., a weekly update provided the item has not already been sold).

The sojourner engine 309 tracks the various user activities relating to the webpage 307 and specifically tracks success events. For example, a success event may be any of one or more events that lead to a user placing a bid on an item, the user purchasing the item, or the user adding an item to the user's watch list. Specifically, the sojourner engine 309 tracks particular uses of the webpage 307 that seem to more readily illicit a success event (e.g., the webpage 307 displaying a list view versus a gallery view). The various user activities and success events are discussed in more detail, below.

The singularity engine 311, downstream of the sojourner engine 309, relies on the sojourner engine 309 feed as its main data input but may also receive input such as pre-determined or pre-entered data, characteristics, or analysis information. For example, the singularity engine 311 may include outlier removal logic. Certain outliers of data can be removed that can skew or adversely affect an overall result or metrics of the predictive model (the predictive model, discussed below, is based on weighted data (e.g., weighting of variables or factors). In other words, an outlier can be broadly defined as a session that results in a disproportionate amount of a particular user activity. For example, a single user session with 500 bids on a particular item could be considered an outlier. In general terms, outliers can be classified into two broad categories: (1) data representative of BOT activity (e.g., robotic or mechanized bidding activity); and (2) legitimate but unusual transactions. In either case, the singularity engine 311 seeks to remove outliers to improve the fidelity or accuracy of feature measurements received from the sojourner engine 309. The sojourner engine 309 can also implement sophisticated BOT detection and filtering upstream of the singularity engine 311 that eventually flows into the user experience optimizer 305. Although it is impossible to catch all BOT activity, since some BOT activity can be cleverly disguised as human activity, BOT detection and removal algorithms can be periodically updated.

As noted above, outliers can also come from legitimate transactions. For example, a “power user” (e.g., a frequent or highly active bidder or user of a site) bids 50 times in a particularly busy buying session. If the 50 bids are not filtered by the sojourner engine 309 or the singularity engine 311, the predictive model may credit each of the 50 bids to a user experience. The crediting of the 50 bids could potentially skew downstream analysis and optimization decisions based on the bids being included in the predictive model. Managing legitimate outliers can be tricky. The more aggressive the removal logic employed by the singularity engine 311, the cleaner the resulting signal (e.g., the data metric or variable fed into the predictive model) will be, but also the remaining signal becomes smaller. Consequently, the singularity engine 311 can include an on/off switch to control outlier removal of suspected legitimate transactions. If the switch is set to “OFF,” then no outlier removal is performed. If the switch is set on “ON,” then the following exemplary logic may be applied: (1) rank all user sessions for each target metric independently, highest to lowest; and 2) remove the top, for example, 5% of sessions for each metric.

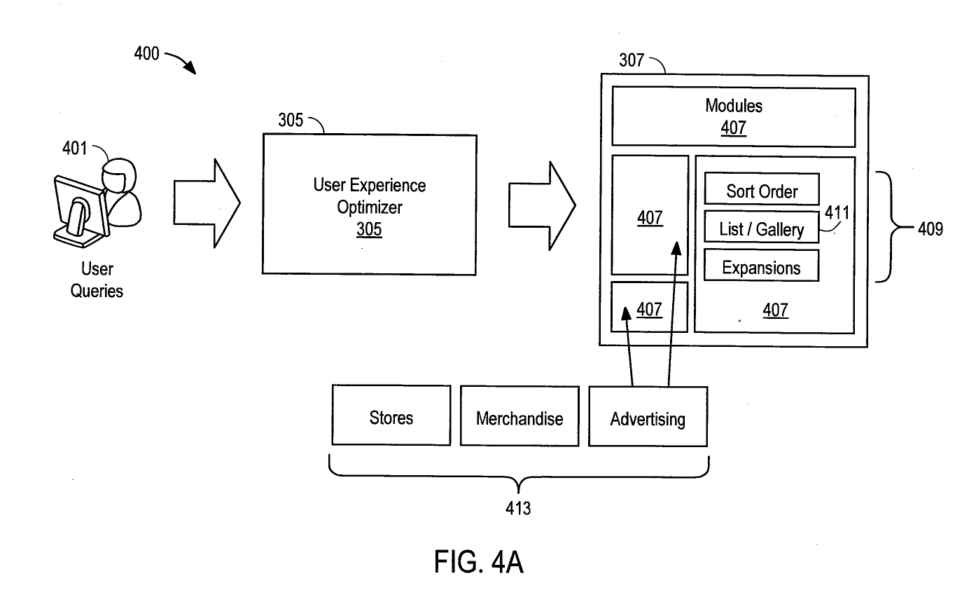

FIG. 4A is an example block diagram 400 of a user community benefiting from the e-purchase or predictive model implemented in the network architecture of FIG. 1. The example block diagram 400 is a specific embodiment of an automated, community-driven, self-learning system. In a community of users 401, networked computer users can use various servers (e.g. websites available via a public network such as the Internet) and search engines to perform various operations. The various operations include searching for items using search queries and a search engine, performing e-commerce transactions, shopping or bidding online for goods or services, browsing for information or items of interest, and the like. Typically, these user operations include some form of user input (e.g., a search query or set of keywords entered as text in an input field of a search engine). The user input provides one form of context input used by the user experience optimizer 305 to automatically customize the user experience for the user community. Other forms of context input collected or used by the user experience optimizer 305 can include, for example, a related product or service category, a user or segment profile or other user information, site identifier (ID), domain, etc. The related product or service category can include one or more categories of products or services that relate to the searches or e-commerce transactions a user (either this user or information based on similar operations by other users) may have currently or previously submitted. The user or segment profile or other user information profile can specify various demographic information, configurations, defaults, preferences, and the like associated with a particular user or group of users. User information can include explicitly or implicitly obtained demographic information, explicitly or implicitly obtained user profile or preference information, user transaction history, user activity history, or any other information explicitly or implicitly obtained that may indicate user preferences. The site identifier (ID) or domain name can specify a particular network location or geographic location associated with a user or group of users. It will be apparent to those of ordinary skill in the art that other information can be retrieved as context information or input associated with a particular point in time.

As shown in FIG. 4A, the context input can be provided to the user experience optimizer 305. As will be described in more detail below, the user experience optimizer 305 includes predictive data and associated computer-implemented rules that can be applied to the context input. The predictive data either assist in or produce decisions or selections related to the type of user experience to present to the user that will represent the most relevant or most likely favored user experience for the user based on the context input. As a result, in a specific embodiment, a user experience, including user interface and available functionality in the form of the webpage 307 can be generated by the user experience optimizer 305. The webpage 307 can include a particular page type selected by the user experience optimizer 305 from a plurality of available page types described herein. The page type can define the structure or arrangement of information and images provided on the webpage. Based on the selected page type, a plurality of modules or widgets 407 can be placed in available locations of the selected page type. The particular modules placed in webpage 307 are selected by the user experience optimizer 305 from a plurality of available page modules or widgets (e.g., list, graphic, data input, etc.). Once the selected modules or widgets 407 are placed in the webpage 307, the information content for each of the modules or widgets 407 is selected by the user experience optimizer 305 from a plurality of available information content sources 413 (e.g., store locations, merchandise listings, advertising items, one or more photographs of the item, photograph size, etc.). Once the content from the selected content sources are placed in the corresponding selected modules or widgets 407, the predictive model, described in detail below, can further configure the information content displayed in the modules or widgets 407 based on the context input. The particular configuration of information content displayed in the modules or widgets 407 of the webpage 307 is selected by the user experience optimizer 305 from a plurality of available information content configurations (e.g., sort order, list or gallery display, expansion display, etc.).

Referring now to FIG. 4B, a more detailed system view of a specific example embodiment of the user experience optimizer is shown. As described above, context input from one or more users is provided to the user experience optimizer 305. The user experience optimizer 305 of a specific embodiment is shown to include an input unit 451 to receive the context input from the various sources described above. Once the context input is collected, aggregated, filtered, and structured by the input unit 451, the processed context input is provided to a predictive data unit 453. The predictive data unit 453 can take the processed context data and form correlations between the context data and the likely desirable structure and content provided in a corresponding user experience. These correlations can be resolved into decisions or selections made by a decision unit 455 based on the correlations made by the predictive data unit 453. The selections made by the decision unit 455 include a selection of page type for the webpage 307, a selection of the modules or widgets 407 (FIG. 4A) for the selected output as the webpage 307, and a selection of configuration of content 411 displayed in the selected modules of the webpage 307.

Once the user experience optimizer 305 produces and displays the webpage 307, the system shown in FIG. 4A can collect user activity feedback 459 from the community of users 401 who interact with the webpage 307. In the community of users 401, networked computer users can use various servers (e.g., websites available via a public network such as the Internet, as noted above) to perform various operations on user interfaces (e.g., various types of displayed pages including the webpage 307), in the form of user activity 457. The user activity 457 can include activities such as searching for items using search queries and a search engine, viewing particular displayed search items, performing e-commerce transactions, shopping or bidding on goods or services, browsing for information or items of interest, and the like. These user-performed operations include various activities performed by the users, such as using a pointing device (e.g., a computer mouse) to select, click, or mouse over various options, items, or links on a webpage, enter a search query or set of keywords, update a user profile, enter text into a user interface provided data entry field, browsing, shopping, bidding or buying online, providing explicit feedback on a user experience, and other types of well-known user interactions with a computer-implemented or other device-implemented (e.g., a browser on a smart phone) user interface. These user activities can be recorded and saved in combination with information indicative of the structure and content of the webpage or the user interface with which the user was interacting at the time the user activity 457 was recorded. The retained version of the user activity feedback 459 can be used to correlate at least elements of the user interface upon which the user acted. In this manner, user relevance or user desire is inferred from the user activity feedback 459. The use of the user activity feedback 459 is described in more detail below in connection with one or more particular embodiments.

With continued reference to FIG. 4B, the user activity feedback 459 is collected from the user activity 457 by a user activity feedback aggregation unit 461. The user activity feedback aggregation unit 461 may be similar to or the same as the sojourner engine 309 (FIG. 3). The user activity feedback aggregation unit 461 produces structured and processed user activity feedback that can be used by the user experience optimizer 305 to adjust the predictive data unit 453. For example, the rules implemented in the predictive data unit 453 can be biased or weighted to produce selections that are more likely favored by the user community based on the user activity feedback 459. Specific example embodiments of weighting of particular feedback recorded are discussed in detail, below.

As also shown in FIG. 4B, the user experience optimizer 305 can also include a separate optimizer for each of a plurality of regions or sites as provided in a series of tabs 463. The regions can include, for example, countries, states, geographical regions, and the like. The sites can include areas served by one or more computing sites, hubs, servers or server farms, and the like. Given a particular region or site tab selection, the user experience optimizer 305 can be configured to produce a different set of customized user interface pages and different associated functionality that are specifically customized for a selected region or site and based on user activity feedback that is relevant for the selected region or site.

FIG. 4B also illustrates that the system of a particular embodiment can include an administrator access or control level 465 that is accessed via an administration console 467. The administrator can cause the generation and display of various reports 469 that highlight internal operations of the user experience optimizer 305. The administration console 467 provides a view into how the user experience optimizer 305 has made decisions over time. For example, the administration console 467 can provide a view into how a decision was made to promote or demote a particular page type, module type, or configuration for a particular set of context input.

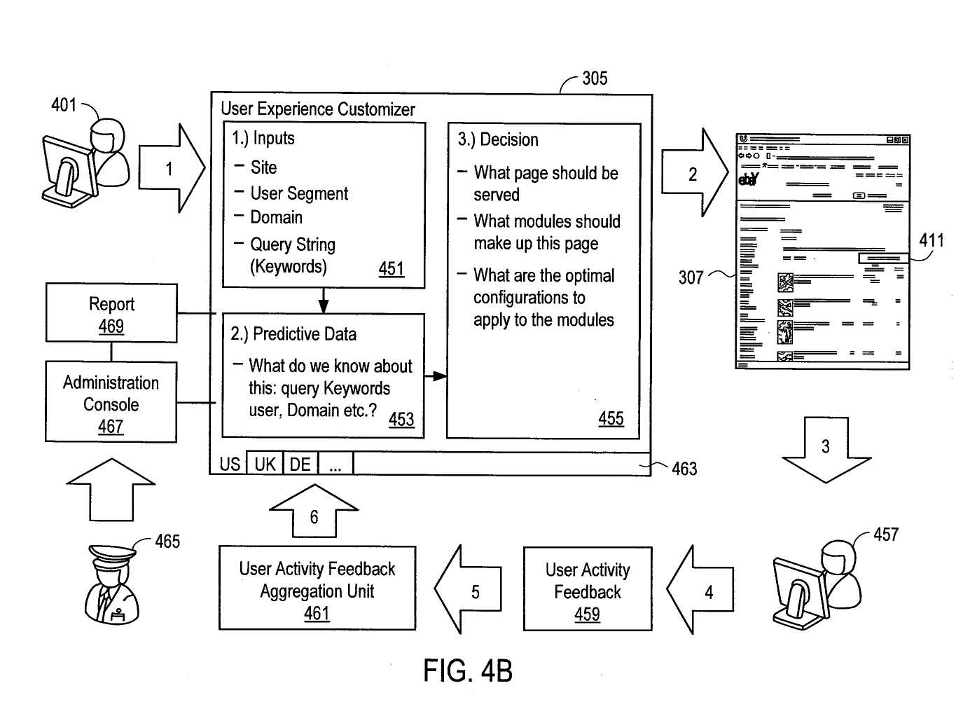

Referring now to FIG. 5, multiple input dimensions 501 and multiple decision or output dimensions 503 of a specific example embodiment are shown. The context input provided to the user experience optimizer 305 can include the multiple input dimensions 501 including, for example, a site 505, a buyer segmentation 507, a domain 509, keywords or search query 511, and other context related data 513. The site 505 information can include a user or buyer name, location, community code, IP address, user profile, and the like. The buyer segmentation 507 can include information that classifies the user or buyer into one or more or purchaser/bidder/shopper groups based on pre-determined criteria. The domain 509 can include information identifying the server, website, merchant, or location, which the user or buyer has accessed. The keywords or search query 511 represents the user keywords or the search query entered by a user. The items or dimensions included in the context information can be dynamically prioritized, re-ordered, or re-grouped so the user experience optimizer 305 can receive an optimal or improved context input available in a given situation. For example, if a particular item or dimension included in the context information does not provide sufficient or accurate information related to the particular dimension, the insufficient or inaccurate dimension can be re-ordered to a less valued (e.g., factored with a lower weighting value) position in the group of context information or the dimension can be eliminated from the context information altogether. In this manner, items or dimensions included in the context information can be ordered or grouped to fall back progressively to other sufficient and accurate dimensions in the group if a particular dimension does not provide sufficient or accurate information for the user experience optimizer 305. As discussed in more detail, below, the multiple input dimensions 501 may be based on a number of other factors or variables other than or in addition to the ones discussed above.

Output produced by the user experience optimizer 305 can include multi-dimensional output, such as selections of one or more page types 515, a module or widget set 517, other configurations 519, or other selections 521 based on or customized from a collection of user activity feedback from a community of users gathered over time. In general, various embodiments use context input, including user and query information and user activity feedback, to automatically generate and display the most relevant or optimized next page for that context using a predictive model.

The predictive model can count various user feedback metrics (e.g., any defined user activity) while on a given site. The metrics can include a bid on an item (in an auction), a buy-it-now (“BIN”) event, or a “Watch Item” as “success events.” In other words, a bid, BIN, or watch is indicative as a successful presentation of items to a user. In a specific example embodiment, discussed in more detail below, BINs may be correlated 1:1 with a purchase. However, a bid and a watch event may or may not ever be converted to a purchase and thus cannot necessarily be correlated with a purchase. Regardless of whether there is a correlation or not, bid and watch events can still be important metrics to monitor as they are still predictive indicators of a potential purchase.

In a specific example embodiment, the predictive model can record activities against, for example, the top 3,000 keywords at the site level, as opposed to the site overall. For example, the keyword “Xbox 360 console” may be in the top 3,000 keywords for the top level characterization of “Video Game.” However, “Xbox 360 console” may not be contained in the top 3,000 queries for the site as a whole. Keywords can be implemented as, for example, exact match only or as keyword clustering. If implemented as an exact match only, for the keyword “iPod” to be credited with a subsequent activity, discussed in more detail below, a user must enter exactly that query into the search. If implemented as keyword clustering, then related words may be credited with the subsequent activity. When implemented as an exact match only, a signal strength at the keyword level can be limited. Top keywords are defined based on an impression count. The list of top keywords may be dynamically refreshed on a periodic basis such as, for example, weekly.

### Probability Regression Models

As noted above, there are substantial differences in variables between a fixed price marketplace (e.g., a BIN item for sale) and an auction marketplace (e.g., a series of progressive bids from a number of auction buyers). However, in both case, a basic probability regression model can be employed. As is known to a skilled artisan, a fixed price model may be expressed by the probability regression model:

$$f ( x ) = \frac{{e}^{x}}{1 + {e}^{x}} ;$$

where f(x) is the probability that a given event will occur and x is a regression coefficient and can effectively be considered a predictor variable. The regression coefficient may be selected from one to a large number of variables that are expected to affect the probability result. Each of these variables can be weighted either linearly or non-linearly. Due to the nature of the regression coefficient, x can take on any rational number (negative or positive) and the result, f(x), will always take a value from 0 to 1, inclusive. Based upon regression analysis derived from actual data, the regression coefficient, x, can be determined based on the chosen variables.

For example, a view-item model for a fixed price marketplace may be based on the number of times an item is viewed in a given day (VI_Count_Sameday), a number of times the item has been watched (Watchers_Cnt), and various other parameters of interest. In a generalized representation, the regression coefficient, x, may take a form of:

$$x = \pm a + {b}_{1} {x}_{1} + {b}_{2} {x}_{2} + … + {b}_{n} {x}_{n} + {c}_{1} {x}_{1 + j}^{2} + {c}_{2} {x}_{2 + j}^{2} + … + {c}_{j} {x}_{n + j}^{2} + … + {d}_{1} {x}_{1 + k}^{m} + {d}_{2} {x}_{2 + k}^{m} + … + {d}_{k} {x}_{n + k}^{m} ;$$

where a, b, c, and d are coefficients of sub-components of x; x₁, x₂, etc. are sub-component predictor variables of x; n, j, k are integers; and m is a rational exponent (integer or non-integer).

Consequently, in a specific example embodiment, the regression variable may take on a value based on actual data in a form such as:

$$x = - 1.232 + 0.1633 \cdot [ ln ( VI\_Count \_Sameday ) ] + 0.0125 \cdot [ ln ( Watchers\_Cnt ) ] + 0.1047 [ ln ( Click\_cnt ) ] + 1.125 \cdot Item Watched + 1.336 \cdot OtherNextPageID - 0.5181 \cdot [ ln ( current\_price ) ] - 0.0688 \cdot [ ln ( shipping\_csts ) ] - 0.0089 \cdot Search\_No - 0.1284 * Page\_No + 0.291 \cdot MQ + 0.2413 \cdot Paypal\_Buyer \_Protection + 0.26 * ln ( [ {ln ( click\_cnt ]}^{2} )$$

Similarly, in a specific example embodiment, the regression variable, x, in a view-item model for an auction-based marketplace; may take on a value such as:

$$x = - 0.4668 + 0.0839 \cdot [ ln ( VI\_Count \_Sameday ) ] - 0.1704 \cdot [ ln ( Watchers\_Cnt ) ] + 0.289 \cdot [ ln ( Click\_cnt ) ] + 1.516 \cdot Item Watched - 0.7765 \cdot OtherNextPageID + 0.0066 \cdot [ ln ( {[ ln\_VI \_Count \_Sameday ]}^{2} ) ] - 0.0525 \cdot [ ln ( [ ln\_Watchers \_Cnt ] \hat{} 2 ) ] + 0.2463 \cdot [ ln ( {[ ln\_Click \_cnt ]}^{2} ) ] - 0.181 \cdot [ ln ( time\_remaining ) ]$$

With reference again to FIG. 3, once all of the data are incorporated, the regression variable may be calculated in the parallel processing engine 303 which, in turn, provides feed forward information to the user experience optimizer 305.

### Sample Size Dependency of Regression Models

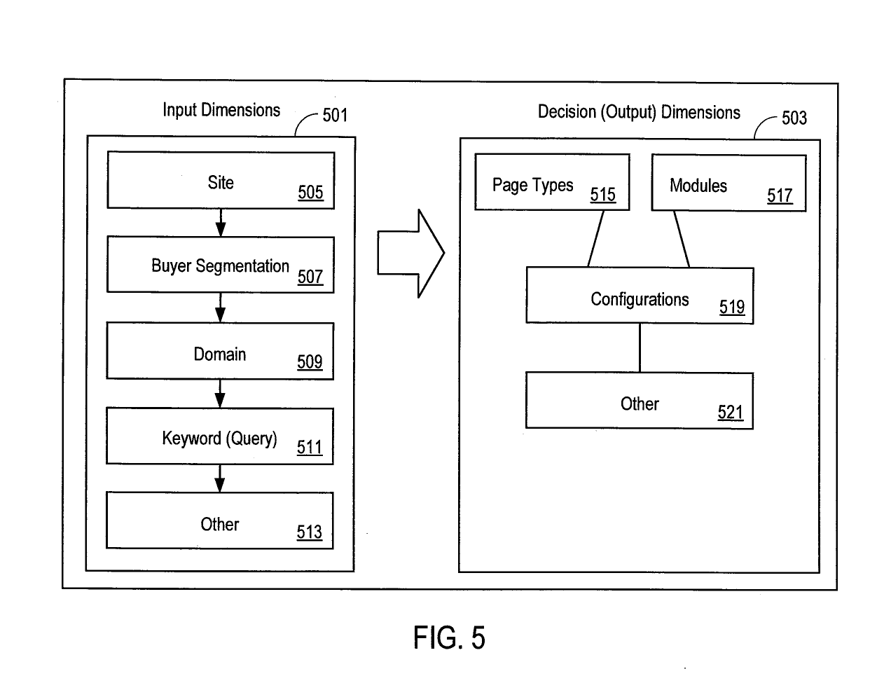

With reference now to FIG. 6A, the graphical representation depicted by the block diagram 600 indicates impressions based on keyword inputs from a user. As used herein, impressions may be considered a count of the number of times a given page, module, or configuration was presented to a user. An increased signal indicates that substantially more data are available based on a given keyword. In the case of the keyword “iPod,” tens of millions of searches (“impressions”) for the term “iPod” may have been performed in a given time period.

Conversely, a much smaller signal is obtained for searches (and any resulting impressions) made for the keyword “red dress.” Thus the sample size, and consequently the number of impressions, for “red dress” is several orders of magnitude lower for “red dress” than the sample size for “iPod.” Regression analysis tends to systematically overestimate probabilities of an event occurring when only small or moderate sample sizes are available (e.g., when sample sizes are less than 500 or so). With an increasing sample size (i.e., an increased signal due to an increased number of impressions), an error due to overestimation diminishes and an estimated probability asymptotically approaches a true population value. However, when a standard deviation of error is coupled with the probability estimate, any overestimation may be significantly less relevant than the actual probability, without the standard deviation, may indicate.

With reference to FIG. 6B, a portion of a web browser 630 is shown. By clicking on a back button 631 of the portion of the web browser 630, the user will go back one page to the most recently viewed page. Most browsers cache the preceding pages, so there is no call to the server that can be tracked when the user clicks on the back button 631. Although the use of a back button in browsers is common, the back button 631 can affect the calculation of the impressions of FIG. 6A. For example, after a user makes a query using search terms, the user may click on one of the listed items from the search. If the user clicks the back button within a predetermined time period (e.g., within 10 seconds), the calculation of “view item” associated with an associated keyword may not be counted toward an overall score. The reason for this exclusion is based upon an assumption that the user really did not mean to click on, and consequently view, this particular item since (1) the time frame the user stayed on the item page was short; and (2) the user clicked no other items directly on the item page (such as, for example, additional photographs of the item, shipping terms, more information, etc.). Thus, the assumed “erroneous” view item tally can be excluded so as not to skew the overall results distribution.

In a similar manner, a portion of the web browser 650 in FIG. 6C shows a “Back to Search Results” button 651. As with the back button 631 of FIG. 6B, if a user fails to perform certain activities on an item page such as, for example, remain on the page more than a pre-determined time or fails to click any other button on the item page, the assumed “erroneous” view item tally can be excluded so as not to skew the overall results distribution. In other example embodiments however, any click to view an item can be considered a valid view item regardless of the time frame that the user lingers on the page. Thus, any view item click can always be included regardless of whether the user fairly rapidly clicks the back button 631 or the back to search results button 651.

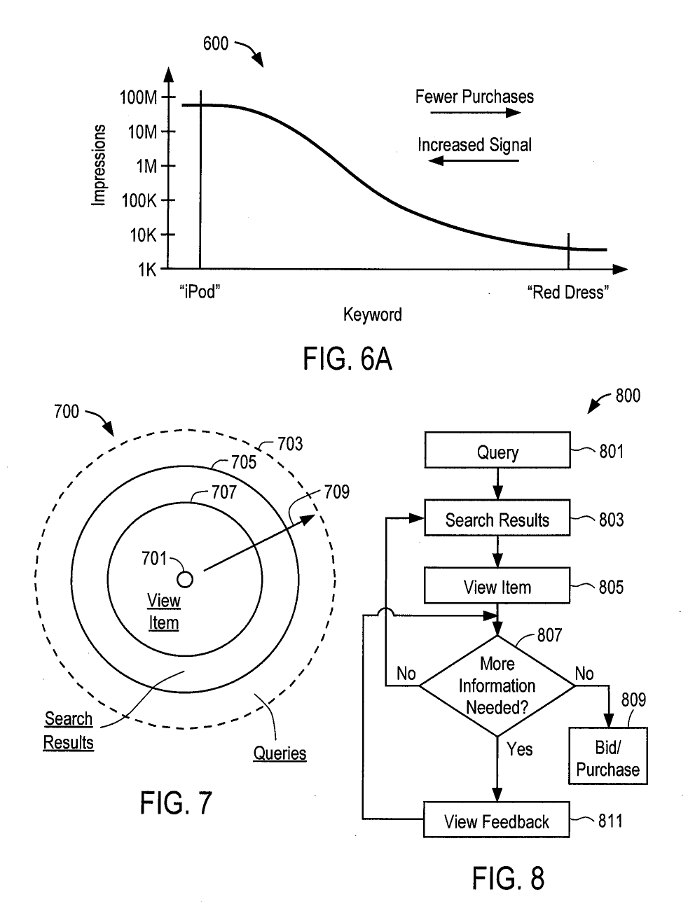

Referring now to FIG. 7, a representational diagram 700 of a hierarchy of user events is shown that are used in a specific example embodiment of the predictive model. In an electronic marketplace, there may be hundreds or thousands of purchase events each day. For each purchase event 701, there is a substantially larger “universe” of queries 703 that led to the purchase event 701. The queries 703 produced a significant number of search results 705. In turn, the search results 705 produced a number of view item events 707. The view item events 707 eventually produced the purchase event 701. Consequently, an overall signal can effectively be boosted by backing through the events since there are an increasing number 709 of activities backtracking from the purchase event 701 back through to the queries 703. Thus, an increased signal can be deduced from the activities leading up to the sale and fed into the predictive model discussed, above.

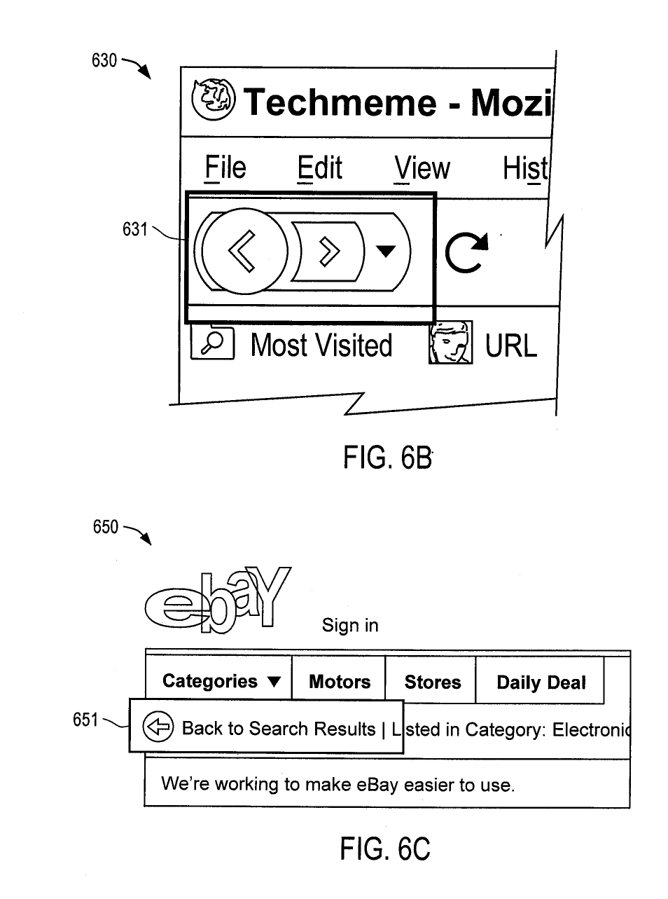

In FIG. 8, a flowchart 800 indicates user events that are used in a specific example embodiment of the predictive model. After a user makes a query at operation 801 using, for example, certain keywords or search strings, a search server produces and returns to a browser of the user, search results at operation 803. The user peruses the returned search results and selects a particular item during a view item event at operation 805. The user makes a decision, at operation 807, whether more information is required to make a decision or whether to purchase or bid on the viewed item. If the user determines more information is not required, then the user may simply choose to bid on or purchase the item, at operation 809, or, alternatively, the user may determine this particular item is not one upon which the user wishes to place a bid or make a purchase. The determination not to bid or purchase may be made based on one or a variety of factors such as price, color, size, or a variety of other determining factors. When the user makes a determination not to bid or purchase the item, the user may simply select to return back to the search results page at operation 803. Alternatively, if at operation 807 the user determines that more information is needed, the user may choose to obtain more information such as, for example, view the feedback of the seller at operation 811. A skilled artisan will immediately recognize that the user may alternatively choose to select a variety of other information as well (not shown explicitly) such as viewing additional photographs of the item, viewing shipping information for the item, viewing payment methods for the item, and so on. Once the user has viewed the additional information, the user may again choose to view even more information about the item, bid on or purchase the item, or return to the search results page. Regardless of which path or paths the user decides to pursue, all of the information is recorded (by, for example, the sojourner engine 309 of FIG. 3) and tracked as a series of variables to be used in calculation of the activity scoring and predictive models, discussed above.

The various embodiments described above present a useful solution to a current technical problem: using, for example, one or more processors to perform a search over a potentially huge inventory (numbers may be well into the millions) of items, involving a large numbers of sellers of the items, and present the results of the search to the end-user in a manner most likely to increase the experience of the user and present results to the user in a more inviting way. The various activities of the user can be tracked, perhaps even anonymously with reference to an identity of the user, and by applying the activities of the user, can increase the usefulness and the experience to the user visiting the site. Additionally, there is currently no mechanism to get insights at category levels of particular items for bid or purchase. For the most part, decision making is manual where business owners placing the items onto the online marketplace make decisions regarding the item. The subject matter described herein allows automation of at least some of the decision making. For example, determining what causes a particular success event (a purchase), whether that be, for example, a list view versus a gallery view, a size of a picture of the item, multiple pictures of the item, and so forth, can effectively be aided by the predictive model.

While various embodiments of the present invention are described with reference to assorted implementations and exploitations, it will be understood that these embodiments are illustrative only and that a scope of the present inventions are not limited to them. In general, techniques for the searches or methods described herein may be implemented with facilities consistent with any hardware system or hardware systems defined herein and the variables gleaned from the searches can be applied in a variety of ways with, for example, various weightings applied to each of the variables. Consequently, many variations, modifications, additions, and improvements are possible.

Plural instances may be provided for resources, operations, or structures described herein as a single instance. Finally, boundaries between various resources, operations, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of the present invention that is represented by the appended claims.

### Modules, Components, and Logic

Additionally, certain embodiments described herein may be implemented as logic or a number of modules, components, or mechanisms. A module, logic, component, or mechanism (collectively referred to as a “module”) may be a tangible unit capable of performing certain operations and is configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by cost and time considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time. Other embodiments contemplate one or more of the various engines or modules being implemented in hardware including, for example, computer processors, field programmable gate arrays (FPGAs), application specific integrated circuits (ASICs), or other types or hardware known to a skilled artisan.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and

### Machine-Readable Storage Medium

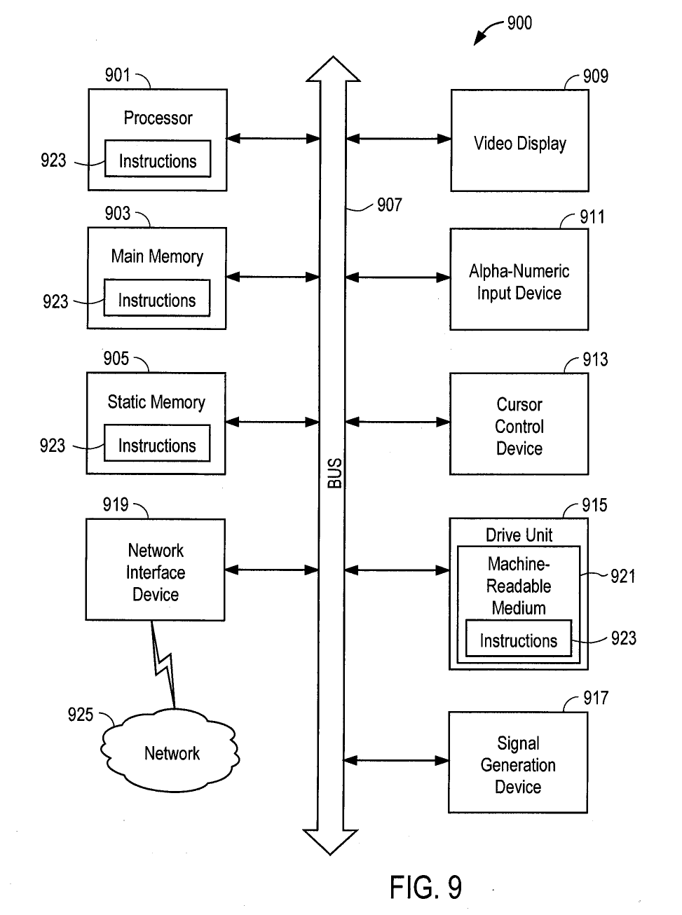

With reference now to FIG. 9, an example embodiment extends to a machine in the form of a computer system 900 within which instructions, for causing the machine to perform any one or more of the methodologies discussed herein, may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

In this example embodiment, the computer system 900 includes a processor 901 (e.g., a central processing unit (CPU), a graphics processing unit (GPU) or both), a main memory 903 and a static memory 905, which communicate with each other via a bus 907. The computer system 900 may further include a video display unit 909 (e.g., a liquid crystal display (LCD) or a cathode ray tube (CRT)). The computer system 900 also includes an alphanumeric input device 911 (e.g., a keyboard), a user interface (UI) navigation device or cursor control device 913 (e.g., a mouse), a disk drive unit 915, a signal generation device 917 (e.g., a speaker), and a network interface device 919.

### Machine-Readable Medium

The disk drive unit 915 includes a machine-readable medium 921, for example, a machine-readable storage medium, on which is stored one or more sets of instructions and data structures (e.g., software 923) embodying or used by any one or more of the methodologies or functions described herein. The software 923 may also reside, completely or at least partially, within the main memory 903 or within the processor 901 during execution thereof by the computer system 900; the main memory 903 and the processor 901 also constituting machine-readable media.

While the machine-readable medium 921 is shown in an example embodiment to be a single medium, the term “machine-readable medium” or “computer-readable medium” may include a single medium or multiple media (e.g., a centralized or distributed database, or associated caches and servers) that store the one or more instructions. The term “machine-readable medium” or, similarly, “machine-readable storage medium” or “non-transitory machine-readable storage medium” shall also be taken to include any tangible medium that is capable of storing, encoding, or carrying instructions for execution by the machine or computer and that cause the machine to perform any one or more of the methodologies of the present invention, or that is capable of storing, encoding, or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., EPROM, EEPROM, and flash memory devices); magnetic disks such as internal hard disks and removable disks; magneto-optical disks; and CD-ROM and DVD-ROM disks.

### Transmission Medium

The software 923 may further be transmitted or received over a communications network 925 using a transmission medium via the network interface device 919 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually or collectively, by the term “invention” merely for convenience and without intending to voluntarily limit the scope of this application to any single invention or inventive concept if more than one is, in fact, disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

For example, particular embodiments describe various arrangements, algorithms, programming tools, and topologies of systems. A skilled artisan will recognize, however, that additional embodiments may be focused on electronic business applications and accompanying system architectures in general and not specifically to electronic searching of consumer sites. Consequently, these and various other embodiments are all within a scope of the present invention. The specification and drawings are, accordingly, to be regarded in an illustrative rather than a restrictive sense.

What is claimed is:

1. A method of enhancing a user experience in an online environment, the method comprising:
receiving a request over a network from a user, the request including keywords to be used in a search for one or more items;
displaying results from the search in a webpage;
making a determination whether to track metrics related to user activities associated with the results from the search; and
based on the determination that the user activities are tracked:
determining factors based on the tracked metrics related to the user activities; and
calculating a predictive model using one or more processors, the calculating of the predictive model being based on the determined factors based on the tracked metrics.

2. The method of claim 1, further comprising displaying an enhanced webpage, a selection of components in the enhanced webpage being based on the predictive model.

3. The method of claim 1, wherein the user activities include at least one of a view of at least one item from the results of the search, a bid on the at least one item from the results of the search, and a purchase of the at least one item from the results of the search.

4. The method of claim 3, further comprising:
backing through and including the user activities that produced the purchase of the at least one item from the results of the search;
applying a weighting factor to each of the user activities that produced the purchase, thereby resulting in a weighted user activity; and
including the weighted user activity in the calculating of the predictive model.

5. The method of claim 1, further comprising making a determination whether to exclude outlier data from the calculating of the predictive model.

6. The method of claim 5, wherein the outlier data is excluded based on at least one or suspected BOT activity and unusually large numbers of transaction from a single user.

7. The method of claim 1, wherein the determination whether to track the user activities is at least partially based on one or more finding attempts of the user.

8. The method of claim 1, wherein the predictive model is a probability regression model.

9. The method of claim 8, wherein the factors based on the tracked metrics are used as probability coefficients in the probability regression model.

10. The method of claim 1, further comprising applying weighting factors to the tracked metrics prior to calculating the predictive model.

11. The method of claim 1, further comprising applying a geographic region of the user as an additional factor to the calculating of the predictive model.

12. A system to enhance a user experience in an online environment, the system comprising:
a parallel processing engine to make a determination, using one or more processors, whether to track metrics related to user activities associated with results from a search based on keywords submitted by a user, the parallel processing engine further to calculate a predictive model based on a set of determined factors based on the tracked metrics;
a user experience optimizer to compile information received from the parallel processing engine, the user experience optimizer further to prepare items to be included in a webpage based upon the information received from the parallel processing engine;
a sojourner engine to track metrics related to the user activities associated with the results from the search; and
a singularity engine incorporating outlier removal logic, the outlier removal logic to remove outliers from the tracked metrics received from the sojourner engine, results from the tracked metrics with the removed outliers to be used as an input to the parallel processing engine.

13. The system of claim 12, wherein the user activities include at least one of a view of at least one item from the results from the search, a bid on the at least one item from the results from the search, and a purchase of the at least one item from the results of the search.

14. The system of claim 13, wherein the sojourner engine is further to:
include the user activities that produced the purchase of the at least one item from the results of the search;
apply a weighting factor to each of the user activities that produced the purchase, thereby resulting in a weighted user activity; and
include the weighted user activity to be used to calculate the predictive model.

15. The system of claim 12, wherein the predictive model is a probability regression model and the parallel processing engine is to apply the determined factors based on the tracked metrics as probability coefficients in the probability regression model.

16. The system of claim 12, wherein the parallel processing engine is further to apply weighting factors to the tracked metrics prior to calculating the predictive model.

17. The system of claim 12, wherein the parallel processing engine is further to apply a geographic region of the user as an additional factor to calculate the predictive model.

18. A non-transitory computer-readable storage medium comprising instructions that, when executed by one or more processors, perform a method of enhancing a user experience in an online environment, the method comprising:
receiving a request over a network from a user, the request including keywords to be used in a search for one or more items;
displaying results from the search in a webpage;
making a determination whether to track metrics related to user activities associated with the results from the search; and
based on the determination that the user activities are tracked:
determining factors based on the tracked metrics related to the user activities; and
calculating a predictive model using the one or more processors, the calculating of the predictive model being based on the determined factors based on the tracked metrics.

19. The non-transitory computer-readable storage medium of claim 18, further comprising displaying an enhanced webpage, a selection of components in the enhanced webpage being based on the predictive model.

20. The non-transitory computer-readable storage medium of claim 18, further comprising:
backing through and including the user activities that produced a purchase of at least one item from the results of the search;
applying a weighting factor to each of the user activities that produced the purchase, thereby resulting in a weighted user activity; and
including the weighted user activity in the calculating of the predictive model.
